(19) United States
(12) Patent Application Publication
(10) Pub. No.: US 2023/0376403 A1
(43) Pub. Date: Nov. 23, 2023

(54) DEBUG DEVICE, DEBUG SYSTEM, AND DEBUG METHOD FOR TESTING STORAGE DEVICE

(71) Applicant: SK hynix Inc., Gyeonggi-do (KR)

(72) Inventor: Jeen PARK, Gyeonggi-do (KR)

(21) Appl. No.: 18/076,027

(22) Filed: Dec. 6, 2022

(30) Foreign Application Priority Data
May 20, 2022 (KR) 10-2022-0062267

(51) Int. Cl. G06F 11/36; G06F 11/07

(52) U.S. Cl. CPC G06F 11/366; G06F 11/3656; G06F 11/0772

(57) ABSTRACT

Provided herein may be a debug device, a debug system, and a debug method. The debug device may include a communicator coupled to a debug interface of a storage device, an interrupt signal generator configured to, when a request to measure an operation time for an instruction is received, output an interrupt signal for controlling an interrupt operation to be performed by the storage device, through the communicator, a tick count detector configured to acquire first tick counts corresponding to a start time point and an end time point of the interrupt operation and acquire second tick counts corresponding to a start time point and an end time point of the instruction, through the communicator, and a calibrator configured to determine the operation time using the first tick counts and the second tick counts.

### CROSS-REFERENCE TO RELATED APPLICATION

The present application claims priority under 35 U.S.C. § 119(a) to Korean patent application number 10-2022-0062267, filed on May 20, 2022, the entire disclosure of which is incorporated herein by reference.

### BACKGROUND

### Field of Invention

Various embodiments of the present disclosure generally relate to an electronic device, and more particularly to a debug device, a debug system, and a debug method for testing a storage device.

### Description of Related Art

A debug device, for example, a debugger or debugging tool, is a device which tests and analyzes another electronic device or storage device, to perform various purposes such as error verification or performance measurement.

The debug device may measure the operation time of an electronic device based on a tick count acquired from the electronic device. For this, a developer has the difficulty of individually modifying/inserting code so that the electronic device stores a tick count value in a specific internal region (e.g., a register of a core) in consideration of various environments of the electronic device. Further, a problem may arise in that the time required by the electronic device to store a tick count value acts as latency, and thus the measured operation time is not accurate.

Accordingly, there is required a scheme for more accurately and conveniently measuring an operation time.

### SUMMARY

Various embodiments of the present disclosure are directed to a debug device, a debug system, and a debug method, which measure accurate operation time of a storage device.

An embodiment of the present disclosure may provide for a debug device. The debug device may include a communicator coupled to a debug interface of a storage device, an interrupt signal generator configured to output, when a request to measure an operation time for an instruction is received, an interrupt signal for controlling an interrupt operation to the storage device through the communicator, a tick count detector configured to acquire first tick counts respectively corresponding to a start time point and an end time point of the interrupt operation through the communicator and acquire second tick counts respectively corresponding to a start time point and an end time point of executing the instruction through the communicator, and a calibrator configured to determine the operation time using the first tick counts and the second tick counts.

An embodiment of the present disclosure may provide for a debug system. The debug system may include a storage device including a memory device, a controller configured to control the memory device, and a debug interface, a debug device configured to output, when a request to measure an operation time for an instruction is received, an interrupt signal for controlling an interrupt operation to the controller through the debug interface, acquire first tick counts respectively corresponding to a start time point and an end time point of the interrupt operation through the debug interface and acquire second tick counts respectively corresponding to a start time point and an end time point of executing the instruction, through the debug interface, and output the first tick counts and the second tick counts, and a host device configured to output the request to the debug device and determine the operation time using the first tick counts and the second tick counts received from the debug device as a response to the request.

An embodiment of the present disclosure may provide for a debug method. The debug method may include, transmitting, when a request to measure an operation time for an instruction is received, an interrupt signal for controlling an interrupt operation to a controller of a storage device through a debug interface of the storage device, acquiring first tick counts respectively corresponding to a start time point and an end time point of the interrupt operation through the debug interface, acquiring second tick counts respectively corresponding to a start time point and an end time point of executing the instruction through the debug interface, and determining the operation time using the first tick counts and the second tick counts.

### BRIEF DESCRIPTION OF THE DRAWINGS

FIG. 1 is a diagram illustrating a debug system according to an embodiment of the present disclosure.

FIG. 2 is a diagram illustrating a debug device and a controller according to an embodiment of the present disclosure.

FIG. 3A is a diagram illustrating the flow of an operation according to an embodiment of the present disclosure.

FIG. 3B is a diagram illustrating a method of determining an operation time according to an embodiment of the present disclosure.

FIG. 4 is a flowchart illustrating a debug method according to an embodiment of the present disclosure.

### DETAILED DESCRIPTION

Specific structural or functional descriptions of the embodiments of the present disclosure introduced in this specification are provided as examples to describe embodiments according to the concept of the present disclosure. The embodiments according to the concept of the present disclosure may be practiced in various forms, and should not be construed as being limited to the embodiments described in the specification.

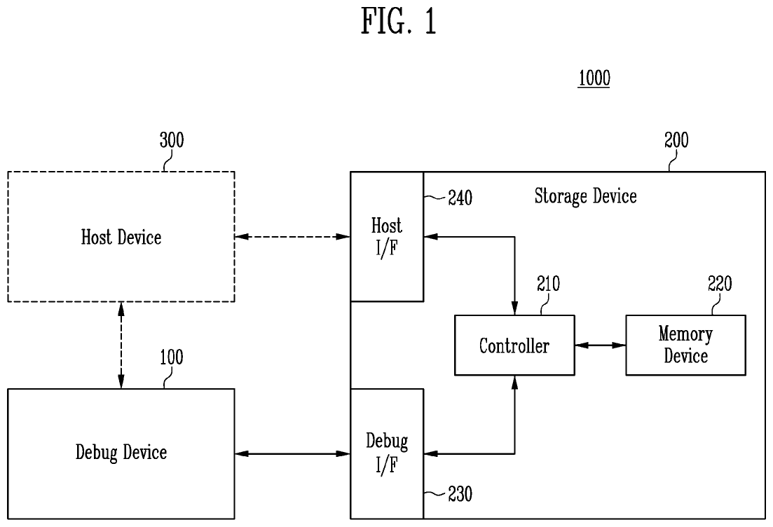

FIG. 1 is a diagram illustrating a debug system according to an embodiment of the present disclosure.

Referring to FIG. 1, a debug system 1000 according to an embodiment of the present disclosure may include a debug device 100, a storage device 200, and a host device 300.

The debug device 100 may perform a debugging function on the storage device 200. In an embodiment, the debug device 100 may test the inside of the storage device 200, may measure the performance of the storage device 200, or may control the storage device 200. For this operation, the debug device 100 may be coupled to a debug interface 230 of the storage device 200. For example, the debug device 100 may transfer a control signal for controlling the storage device 200 through the debug interface 230. The debug device 100 may load information stored in the storage device 200 through the debug interface 230.

The storage device 200 may be an electronic device capable of storing data. For example, the storage device 200 may be implemented as a solid state drive or a solid state disk (SSD) device, a secure digital (SD) card device, a mini-SD card device, a micro-SD card device, a multimedia card (MMC) device, an embedded MMC (eMMC) device, a universal serial bus (USB) storage device, or a universal flash storage (UFS) device. However, this is only an embodiment, and the storage device 200 of the present disclosure may be implemented as a desktop computer, a laptop computer, a smartphone, or the like. In this way, the storage device 200 may be applied to various electronic devices without being limited to specific implementation forms.

The storage device 200 may include a controller 210, a memory device 220, a debug interface (Debug I/F) 230, and a host interface (Host I/F) 240.

The controller 210 may control the overall operation of the storage device 200. For example, the controller 210 may control the memory device 220 so that the memory device 220 performs a program operation of storing data, a read operation of requesting stored data, or an erase operation of erasing the stored data. For this, the controller 210 may be implemented as a central processing unit (CPU), an application processor (AP), a processor or the like.

The memory device 220 may store data. For example, the memory device 220 may be implemented as any of various types of semiconductor memory devices. For example, the memory device 220 may be implemented as a NAND flash memory device, a NOR flash memory device, a static random access memory (SRAM), a dynamic RAM (DRAM), or the like.

The debug interface 230 may communicate with the debug device 100 in compliance with various communication standards. For example, the debug interface 230 may communicate with the debug device 100 in compliance with any of various communication standards such as joint test action group (JTAG), compact JTAG (cJTAG), and a serial wire debug (SWD) method.

The host interface 240 may communicate with the host device 300 in compliance with various communication standards or interfaces. For example, the host interface 240 may perform communication in compliance with any of various communication standards or interfaces, such as peripheral component interconnection (PCI), PCI-express (PCI-e or PCIe), advanced technology attachment (ATA), serial-ATA (SATA), parallel-ATA (PATA), universal serial bus (USB), small computer system interface (SCSI), enhanced small disk interface (ESDI), integrated drive electronics (IDE), Firewire, universal flash storage (UFS), universal asynchronous receiver/transmitter (UART), and Thunderbolt.

The storage device 200 may be operated in response to a request from the host device 300 coupled thereto through the host interface 240. In detail, the storage device 200 may perform an operation corresponding to a request received from the host device 300. For example, when a request to store data is received from the host device 300, the storage device 200 may store the data therein. For example, when a request to read data is received from the host device 300, the storage device 200 may provide the data stored therein to the host device 300.

The host device 300 may be one of various electronic devices such as a desktop computer, a laptop computer, a smartphone, a game console, a television (TV), a tablet computer, a set-top box, a washing machine, a robot, a refrigerator, an artificial intelligence speaker, a wearable device, a central processing unit (CPU), an accelerated processing unit (APU), a graphic processor unit (GPU), and a neural processing unit (NPU).

The debug device 100 may be operated by the host device 300 having higher control authority, or may be operated independently of the host device 300.

In accordance with an embodiment of the present disclosure, the accurate operation time of the storage device 200 may be measured using the debug device 100. Hereinafter, embodiments of the present disclosure will be described in detail with reference to the attached drawings.

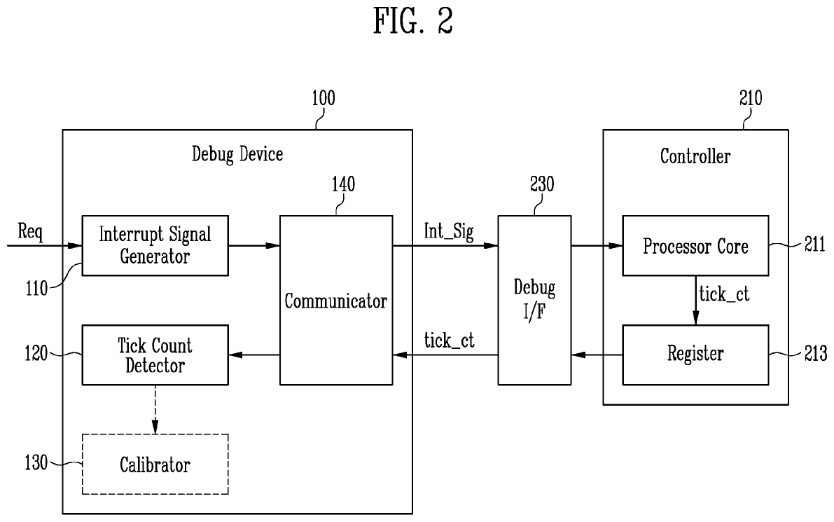

FIG. 2 is a diagram illustrating a debug device and a controller according to an embodiment of the present disclosure.

Referring to FIG. 2, in an embodiment, the debug device 100 may include an interrupt signal generator 110, a tick count detector 120, a calibrator 130, and a communicator 140. In an embodiment, the controller 210 may include a processor core 211 and a register 213.

When a request Req to measure an operation time for an instruction is received, the interrupt signal generator 110 of the debug device 100 may output an interrupt signal Int_Sig to the storage device 200 through the communicator 140.

In an embodiment, the request Req may be received from the host device 300. In an embodiment, the request Req may be user input received through an input device included in the debug device 100. For example, the input device may be a user touch screen, a button, key or the like.

Here, the interrupt signal Int_Sig may be a signal for controlling the processor core 211 of the storage device 200 to perform an interrupt operation. In an embodiment, the interrupt signal Int_Sig may include information about a predefined interrupt operation.

When the interrupt signal Int_Sig is received from the debug device 100 through the debug interface 230, the processor core 211 of the storage device 200 may perform an interrupt operation.

In an embodiment, the processor core 211 may suspend an operation being performed in a normal routine in response to the interrupt signal Int_Sig. The processor core 211 may switch from the normal routine to an interrupt routine, and may perform an interrupt operation during the interrupt routine.

In an embodiment, the interrupt operation may be an operation in which the processor core 211 stores a tick count tick_ct in the register 213. The tick count tick_ct may be a value that gradually increases depending on the logic states of a clock signal in which a first logic state (e.g., 0) and a second logic state (e.g., 1) are periodically repeated. For example, when the clock signal changes from 0 to 1, the value of the tick count may be increased by 1. The clock signal may be a signal for synchronizing the operation of the processor core 211.

When the interrupt operation is completed, the processor core 211 may switch to the normal routine, and may resume the operation suspended in the normal routine.

Thereafter, the processor core 211 may execute instructions for measuring an operation time. Here, the instructions refer to machine language instructions. For example, the instructions may indicate machine language instructions/commands such as four fundamental arithmetic operations, logical operations, commands for writing and reading to and from a memory, a branch command, and a call command.

The tick count detector 120 may acquire first tick counts respectively corresponding to the start time point and the end time point of the interrupt operation through the communicator 140. Here, the first tick counts may include a first start tick count indicating the start time point of the interrupt operation and a first end tick count indicating the end time point of the interrupt operation. That is, the first start tick count may be a tick count when the interrupt operation starts, and the first end tick count may be a tick count when the interrupt operation is completed.

The tick count detector 120 may acquire second tick counts respectively corresponding to the start time point and end time point of an instruction through the communicator 140. Here, the second tick counts may include a second start tick count indicating the start time point of executing the instruction and a second end tick count indicating the end time point of executing the instruction. That is, the second start tick count may be a tick count when the execution of the instruction starts, and the second end tick count may be a tick count when the execution of the instruction is completed.

The calibrator 130 may determine the operation time for the instruction using the first tick counts and the second tick counts.

In an embodiment, the calibrator 130 may obtain a subtraction value by subtracting the difference between the first tick counts from the difference between the second tick counts. The calibrator 130 may acquire a value, obtained by dividing the subtraction value by the speed of the processor core 211, as the operation time. The speed of the processor core 211 may be obtained through the communicator 140.

The communicator 140 may be coupled to the debug interface 230 of the storage device 200. The communicator 140 may be a plug or a socket, which uses the same communication method as the debug interface 230, among communication methods such as joint test action group (JTAG), compact JTAG (cJTAG), and serial wire debug (SWD).

In an embodiment, the communicator 140 may communicate with the debug interface 230 using the joint test action group (JTAG) method. For example, the debug interface 230 may include a test data input (TDI) pin and a test data output (TDO) pin. The communicator 140 may receive a data signal for performing a test through the TDI pin. The communicator 140 may obtain information about test results through the TDO pin. For example, the communicator 140 may receive an interrupt signal through the TDI pin. For example, the communicator 140 may acquire the tick counts stored in the register 213 through the TDO pin.

In an embodiment, the communicator 140 may be coupled to the debug interface 230 different from the host interface 240, among a plurality of ports included in the storage device 200. That is, the debug interface 230 may be a separate interface different from the host interface 240. In this case, regardless of communication between the host device 300 and the storage device 200, the debug device 100 may perform communication with the storage device 200. Further, the debug device 100 may load tick counts from the storage device 200 without influencing the operation of the controller 210.

Although, in the above-described embodiment, the calibrator 130 is described as being included in the debug device 100, this is only an embodiment, and the calibrator 130 may be modified and practiced to be included in the host device 300.

In a detailed embodiment, the host device 300 may debug the storage device 200 through the debug device 100 coupled to the debug interface 230 of the storage device 200. Here, the host device 300 may communicate with the debug device 100 through a scheme such as USB or Ethernet, and may be a master device having the authority to control the debug device 100.

In this case, the host device 300 may output a request Req to the debug device 100. The debug device 100 may acquire first tick counts and second tick counts from the controller 210 in response to the request Req received from the host device 300. The debug device 100 may transmit the first tick counts and the second tick counts to the host device 300.

Furthermore, the host device 300 may receive the first tick counts and the second tick counts from the debug device 100 as a response to the request Req. The host device 300 may determine the operation time using the first tick counts and the second tick counts.

In an embodiment, the host device 300 may obtain a subtraction value by subtracting the difference between the first tick counts from the difference between the second tick counts. The host device 300 may acquire a value, obtained by dividing the subtraction value by the speed of the processor core 211, as the operation time.

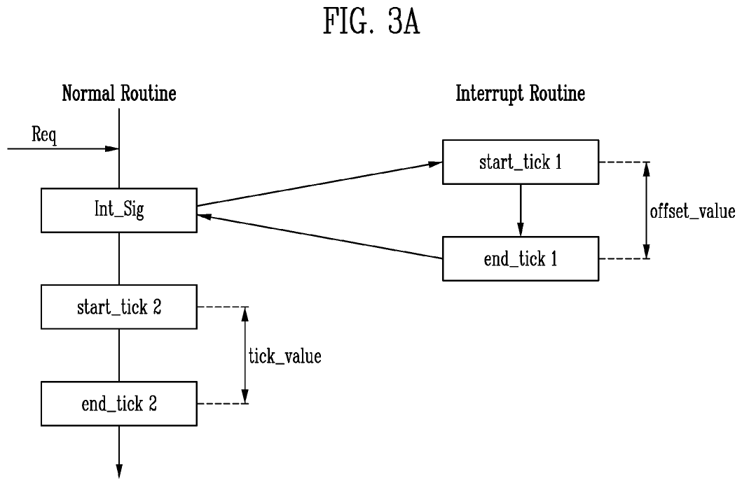

FIG. 3A is a diagram illustrating the flow of an operation according to an embodiment of the present disclosure.

Referring to FIG. 3A, when a request Req to measure an operation time for an instruction is received, a debug device 100 may transmit an interrupt signal Int_Sig to a processor core 211.

When the interrupt signal Int_Sig is received while an operation is being performed in a normal routine, the processor core 211 may switch from the normal routine to an interrupt routine. In this case, the processor core 211 may suspend the operation being performed in the normal routine. The processor core 211 may switch from the normal routine to the interrupt routine, and may perform an interrupt operation during the interrupt routine.

In an example, the processor core 211 may perform an interrupt operation of storing tick counts in a register 213 in response to the interrupt signal Int_Sig. A tick count detector 120 may acquire, as a first start tick count start_tick1, the tick count of the processor core 211 at the time point at which the interrupt signal Int_Sig is output. When the interrupt operation is completed, a tick count may be stored in the register 213. The tick count detector 120 may acquire, as a first end tick count end_tick1, the tick count stored in the register 213.

In an example, the processor core 211 may perform a first interrupt operation of storing a tick count in the register 213 in response to the interrupt signal Int_Sig. When the first interrupt operation is completed, the processor core 211 may perform a second interrupt operation of storing a tick count in the register 213. The tick count stored in the register 213 due to the completion of the first interrupt operation may be the first start tick count start_tick1, and the tick count stored in the register 213 due to the completion of the second interrupt operation may be the first end tick count end_tick1. The tick count detector 120 may acquire the first start tick count start_tick1 and the first end tick count end_tick1 stored in the register 213.

When the interrupt operation is completed, the processor core 211 may switch to the normal routine, and may resume the operation suspended in the normal routine. Thereafter, the processor core 211 may execute an instruction. In this case, the tick count detector 120 may acquire, as a second start tick count start_tick2, the tick count of the processor core 211 at the time point at which the execution of the instruction starts. When the execution of the instruction is completed, the processor core 211 may store a tick count in the register 213. The tick count detector 120 may acquire, as a second end tick count end_tick2, the tick count stored in the register 213.

The calibrator 130 may determine the operation time for the instruction using the first tick counts and the second tick counts.

For example, the calibrator 130 may obtain the difference between the first end tick count end_tick1 and the first start tick count start_tick1 as an offset value offset_value. The offset value offset_value may indicate latency. Further, the calibrator 130 may obtain the difference between the second end tick count end_tick2 and the second start tick count start_tick2 as a tick value tick_value. A method of determining an operation time using the tick value tick_value and the offset value offset_value will be described in detail below with reference to FIG. 3B.

FIG. 3B is a diagram illustrating a method of determining an operation time according to an embodiment of the present disclosure.

Referring to FIG. 3B, the calibrator 130 according to an embodiment may obtain a subtraction value by subtracting the offset value offset_value from the tick value tick_value. The calibrator 130 may acquire a value, obtained by dividing the subtraction value by the speed of the processor core 211, as an operation time ot.

Here, the tick value tick_value may be a value obtained by subtracting a second start tick count from a second end tick count, and the offset value offset_value may be a value obtained by subtracting a first start tick count from a first end tick count.

For example, when the tick value tick_value is 538 cycles, the offset value offset_value is 2 cycles, and the speed is 600 Hz. In this case, when individual values are input to the equation of FIG. 3B, the operation time for the instruction may be calculated as (538−2)/600=0.893 seconds.

In accordance with the foregoing embodiments of the present disclosure, there can be provided the debug device 100 and the debug system 1000, which measure the accurate operation time of the storage device 200. Further, the accurate operation time of the storage device 200 may be more conveniently measured without requiring individual settings depending on the performance of the storage device 200 and compiler options.

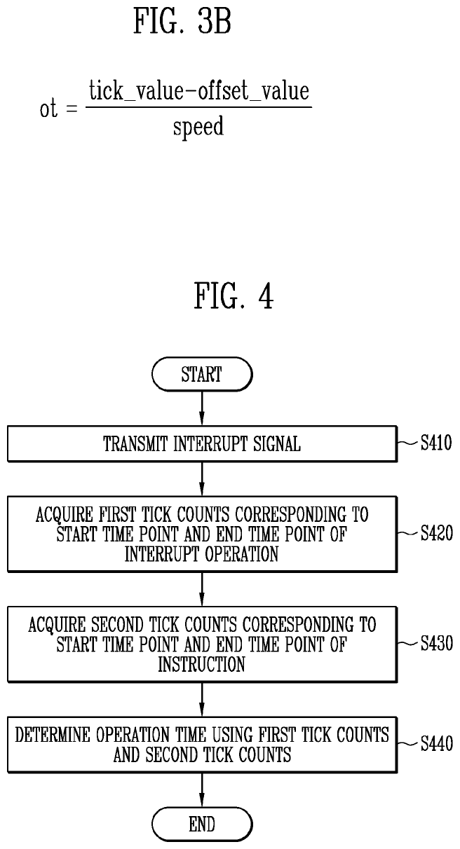

FIG. 4 is a flowchart illustrating a debug method according to an embodiment of the present disclosure.

Referring to FIG. 4, the debug method according to an embodiment of the present disclosure may include, when a request to measure an operation time for an instruction is received, transmitting an interrupt signal for controlling an interrupt operation to be performed to the controller 210 of the storage device 200 through the debug interface 230 of the storage device 200 at operation S410, acquiring first tick counts respectively corresponding to the start time point and the end time point of the interrupt operation through the debug interface 230, at operation S420, acquiring second tick counts respectively corresponding to the start time point and the end time point of executing the instruction through the debug interface 230 at operation S430, and determining an operation time using the first tick counts and the second tick counts at operation S440.

In detail, when the request to measure the operation time for the instruction is received, the interrupt signal for controlling the interrupt operation to be performed may be transmitted to the controller 210 of the storage device 200 through the debug interface 230 of the storage device 200 at operation S410.

In an embodiment, all operations being performed by the processor core 211 included in the controller 210 may be suspended in response to the interrupt signal. Further, the processor core 211 may perform an interrupt operation of storing the tick counts in the register 213 included in the controller 210. After the interrupt operation is completed, the processor core 211 may execute the instruction.

Also, the first tick counts respectively corresponding to the start time point and the end time point of the interrupt operation may be acquired through the debug interface 230 at operation S420.

Here, the first tick counts may include a first start tick count, indicating the time point at which the interrupt operation starts, and a first end tick count, indicating the time point at which the interrupt operation is completed. For example, the processor core 211 of the storage device 200 may store the first start tick count in the register 213 at the time point at which the interrupt operation starts, and may store the first end tick count in the register 213 at the time point at which the interrupt operation is completed. The tick count detector 120 of the debug device 100 may load the first start tick count and the first end tick count from the register 213 through the debug interface 230.

Also, the second tick counts respectively corresponding to the start time point and the end time point of executing the instruction may be acquired through the debug interface 230 at operation S430.

Here, the second tick counts may include a second start tick count, indicating the time point at which the execution of the instruction starts, and a second end tick count, indicating the time point at which the execution of the instruction is completed. For example, the processor core 211 of the storage device 200 may store the second start tick count in the register 213 at the time point at which the execution of the instruction starts, and may store the second end tick count in the register 213 at the time point at which the execution of the instruction is completed. The tick count detector 120 of the debug device 100 may load the second start tick count and the second end tick count from the register 213 through the debug interface 230.

Furthermore, the operation time may be determined using the first tick counts and the second tick counts at operation S440.

In an embodiment, a subtraction value may be obtained by subtracting the difference between the first tick counts from the difference between the second tick counts. Also, a value, obtained by dividing the subtraction value by the speed of the processor core 211, may be determined to be the operation time.

In accordance with the foregoing embodiments of the present disclosure, there can be provided the debug device 100, the debug system 1000, and the debug method, which measure the accurate operation time of the storage device 200. In accordance with embodiments, the accurate operation time of the storage device 200 may be measured without requiring individual settings depending on the performance of the storage device 200 and compiler options.

In accordance with the present disclosure, there are provided a debug device, a debug system, and a debug method, which measure accurate operation time of a storage device.

In accordance with the present disclosure, the accurate operation time of a storage device may be measured without requiring individual settings depending on the performance of the storage device and compiler options.

An operating method of a device according to an embodiment of the present disclosure may include obtaining a first duration of an interrupt operation of a target device by controlling the target device to perform the interrupt operation of suspending all operation other than measuring the first duration, obtaining, after completion of the interrupt operation, a second duration of instruction execution of the target device, and determining a time amount of the instruction execution by dividing, by an operating speed of the target device, a difference between the first and second durations. Each of the first and second durations may be represented by a tick count.

Based on embodiments of the present disclosure described above, the accurate operation time of a storage device may be measured without requiring individual settings depending on the performance of the storage device and compiler options. Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the invention as defined in the following claims. Furthermore, the embodiments may be combined to form additional embodiments.

What is claimed is:

1. A debug device, comprising:
a communicator coupled to a debug interface of a storage device;
an interrupt signal generator configured to output, when a request to measure an operation time for an instruction is received, an interrupt signal for controlling an interrupt operation to the storage device through the communicator;
a tick count detector configured to:
acquire first tick counts respectively corresponding to a start time point and an end time point of the interrupt operation through the communicator, and
acquire second tick counts respectively corresponding to a start time point and an end time point of executing the instruction through the communicator; and
a calibrator configured to determine the operation time using the first tick counts and the second tick counts.

2. The debug device according to claim 1, wherein the interrupt operation is an operation in which a processor core of the storage device stores tick counts in a register of the storage device.

3. The debug device according to claim 2, wherein the calibrator determines the operation time by:
acquiring a subtraction value by subtracting a difference between the first tick counts from a difference between the second tick counts, and
acquiring the operating time by dividing the subtraction value by a speed of the processor core received through the communicator.

4. The debug device according to claim 1, wherein the communicator is coupled to an additional debug interface different from a host interface coupled to a host device among a plurality of ports included in the storage device.

5. The debug device according to claim 1, wherein the communicator is configured to communicate with the debug interface according to a joint test action group (JTAG) standard.

6. A debug system, comprising:
a storage device including a memory device, a controller configured to control the memory device, and a debug interface;
a debug device configured to output, when a request to measure an operation time for an instruction is received, an interrupt signal for controlling an interrupt operation to the controller through the debug interface, acquire first tick counts respectively corresponding to a start time point and an end time point of the interrupt operation through the debug interface, acquire second tick counts respectively corresponding to a start time point and an end time point of executing the instruction through the debug interface, and output the first tick counts and the second tick counts; and
a host device configured to:
output the request to the debug device, and
determine the operation time using the first tick counts and the second tick counts received from the debug device as a response to the request.

7. The debug system according to claim 6,
wherein the controller comprises:
a processor core configured to perform the interrupt operation and execute the instruction; and
a register configured to store the first tick counts and the second tick counts through the processor core, and
wherein the interrupt operation is an operation in which the processor core stores the tick counts in the register.

8. The debug system according to claim 7, wherein the host device determines the operation time by:
acquiring a subtraction value by subtracting a difference between the first tick counts from a difference between the second tick counts, and
acquiring the operation time by dividing the subtraction value by a speed of the processor core.

9. A debug method, comprising:
transmitting, when a request to measure an operation time for an instruction is received, an interrupt signal for controlling an interrupt operation to a controller of a storage device through a debug interface of the storage device;
acquiring first tick counts respectively corresponding to a start time point and an end time point of the interrupt operation through the debug interface;
acquiring second tick counts respectively corresponding to a start time point and an end time point of executing the instruction through the debug interface; and
determining the operation time using the first tick counts and the second tick counts.

10. The debug method according to claim 9, further comprising:
suspending, by a processor core included in the controller, all operations, which are performed in the controller, in response to the interrupt signal;
performing, by the processor core, the interrupt operation of storing tick counts in a register included in the controller; and
executing, by the processor core, the instruction after the interrupt operation is completed.

11. The debug method according to claim 10, wherein the determining the operating time comprises:
obtaining a subtraction value by subtracting a difference between the first tick counts from a difference between the second tick counts; and
acquiring the operating time by dividing the subtraction value by a speed of the processor core.
